(19) United States
(12) Patent Application Publication
(10) Pub. No.: US 2018/0022323 A1
(43) Pub. Date: Jan. 25, 2018

(54) VEHICLE WASH BRUSH MITT

(71) Applicant: Peter D. DeFrancisco, Columbus, OH (US)

(72) Inventor: Peter D. DeFrancisco, Columbus, OH (US)

(21) Appl. No.: 15/217,454

(22) Filed: Jul. 22, 2016

(51) Int. Cl. B60S 1/66

(52) U.S. Cl. CPC B60S 1/66

(57) ABSTRACT

A brush mitt which is removably attachable to existing car wash brushes is provided. The brush mitt generally comprises an inner flexible brush liner for enveloping the brush head and bristles and an outer brush cover for providing an exterior cleaning surface formed in the shape of the wash brush.

### BACKGROUND

The present invention relates to manual vehicle washing devices, more specifically a protective brush mitt for covering manual vehicle wash brushes.

Currently, self-service car washes provide foaming brushes which are basically made up of a wand, a brush head, and bristles at the brush head. A soapy lather is dispensed at the brush head while in use. The lather serves to loosen and remove dirt, grime, and other substances from the exterior of the vehicle as well as provide lubrication of the brush. Typically, bristles used for brushes include plastics such as nylon or animal hair such as hog hair.

Such foaming brushes have disadvantages in their use. Foaming brushes can be ineffective in removing the film that is left behind by dirt, dust and exposure to the elements, as well as by soap used to wash the vehicle. More aggravating is that these brushes have a tendency to scratch vehicles with their bristles. They also trap dirt, sand and grime within the bristles which tend to exacerbate the problem.

The present invention provides an apparatus for reducing these problems. The difficulties inherent in the art are therefore overcome in a way which is simple, user friendly, and efficient—which will provide better and more advantageous results.

### SUMMARY

For the foregoing reasons, what is needed is to provide a brush mitt that can be easily adapted to existing self-serve car wash type brushes. The brush mitt consists of a soft, clean exterior cleaning surface free of dirt, sand and other debris—which efficiently and safely cleans soiled vehicle surfaces. Moreover, the brush mitt can be owned and maintained by the vehicle owner—ensuring that the brush mitt preserves its soft, un-abrasive qualities.

In a version of the invention, a brush mitt which is removably attachable to a car wash brush is provided. The brush mitt generally comprises an inner brush liner for enveloping the brush head and bristles and an outer brush cover for providing an exterior cleaning surface formed in the shape of the wash brush.

In particular, the inner brush liner generally comprises an opening having a perimeter to receive the head of the wash brush, wherein the opening comprises an elastic band positioned about the opening perimeter in order to allow the inner brush liner to expand over and embrace around the brush head. The inner brush liner is configured to be removably attachable to the brush head and the brush cover entirely covers the plurality of bristles. In a version, the inner brush liner includes at least one vent for facilitating egress of soap as supplied by the brush head, the vent having a perimeter.

The outer brush cover has an opening configured to receive and envelope the brush head and the inner brush liner. In a version, the outer brush cover generally comprises at least one vent for facilitating egress of soap exterior of the outer brush. The outer brush cover vent and the inner brush liner vent are stitched together at their respective perimeters, thereby allowing soap to flow from inside the inner brush liner directly exterior to the outer brush cover.

In a version of the invention, it is preferable that the exterior cleaning surface is of a soft material such as a microfiber type material or a chinnelle type cloth.

Still other versions, benefits and advantages of the invention will become apparent to those skilled in the art to which it pertains upon a reading and understanding of the following detailed specification.

### BRIEF DESCRIPTION OF THE DRAWINGS

These and other features, aspects, and advantages of the present invention will become better understood with regard to the following description, appended claims, and accompanying drawings where:

FIG. 1 is a front perspective view of a version of the present invention;

FIG. 2 is an illustrative view showing the brush cover adapted to a vehicle wash brush of the version shown in FIG. 1;

FIG. 3 is a cross-sectional view of the wash brush cover adapted to a brush of the version shown in FIG. 1;

FIG. 4 is an exploded view of the version shown in FIG. 1;

FIG. 5 is top plan view of the version shown in FIG. 1 shown in the closed position;

FIG. 6 is a front side elevation view of the version shown in FIG. 1;

FIG. 7 is a top plan view of the version shown in FIG. 1 shown in the open position;

FIG. 8 is an illustrative view showing the inner brush liner adapted to the wash brush head, exterior of the wash brush outer cover of the version shown in FIG. 1;

FIG. 9 is an illustrative view showing the inner brush liner adapted the wash brush head, positioned within the wash brush outer cover of the version shown in FIG. 6;

FIG. 10 is an illustrative view showing the inner brush liner adapted to the wash brush head, positioned within the outer brush cover in the partially closed position of the version shown in FIG. 1;

FIG. 11 is an illustrative view showing the inner brush liner adapted to the wash brush head, positioned within the outer brush cover in the closed position of the version shown in FIG. 1;

FIG. 12 is an up-close view of the stitched connection at the vent between the inner brush liner and the outer brush cover of the version shown in FIG. 1;

FIG. 13 is an up-close view of a vent of the version shown in FIG. 1; and

FIG. 14 is an up-close view of the vent from inside the inner brush liner of the version shown in FIG. 1.

### DESCRIPTION

Referring now to the drawings wherein the showings are only for purposes of illustrating a preferred version of the invention and not for purposes of limiting the same.

The following detailed description is of the best currently contemplated modes of carrying out exemplary versions of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

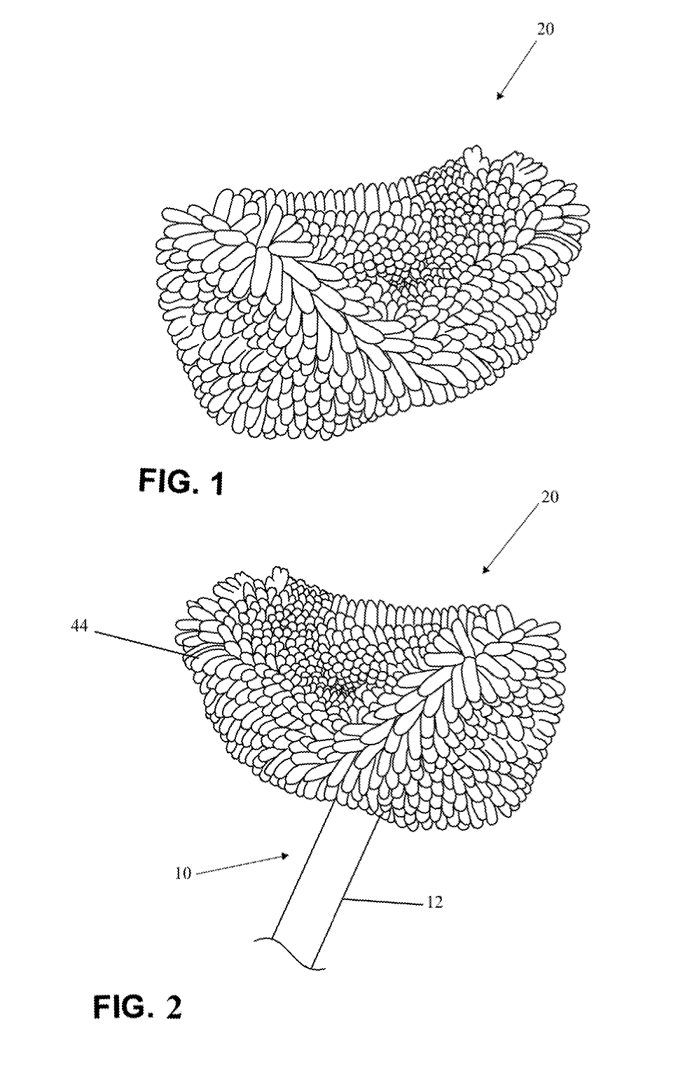

With reference now to the drawings, and in particular to FIG. 1-FIG. 4 thereof, a new brush mitt is provided which is removably attachable to a vehicle wash brush 10 embodying the principles and concepts of the present invention and generally designated by the reference numeral 20 will be disclosed.

As typically found at a self-service car wash, the vehicle wash brush 10 generally comprises a handle 12, head 14, and bristles 16. However, wash brush 10 may be of any commonly employed sort of brush for washing of vehicles and the like. Handle 12 may be hollow in order to receive soapy water through a hose (not shown) attached to handle 12, as commonly the case with the brushes used at self-service car washes. Handle 12 and head 14 may be formed of wood, aluminum, plastic, or any other sufficiently rigid and durable material. Bristles 16 extend downward from brush head 14, and may be formed of nylon, animal hair, or any other bristle material.

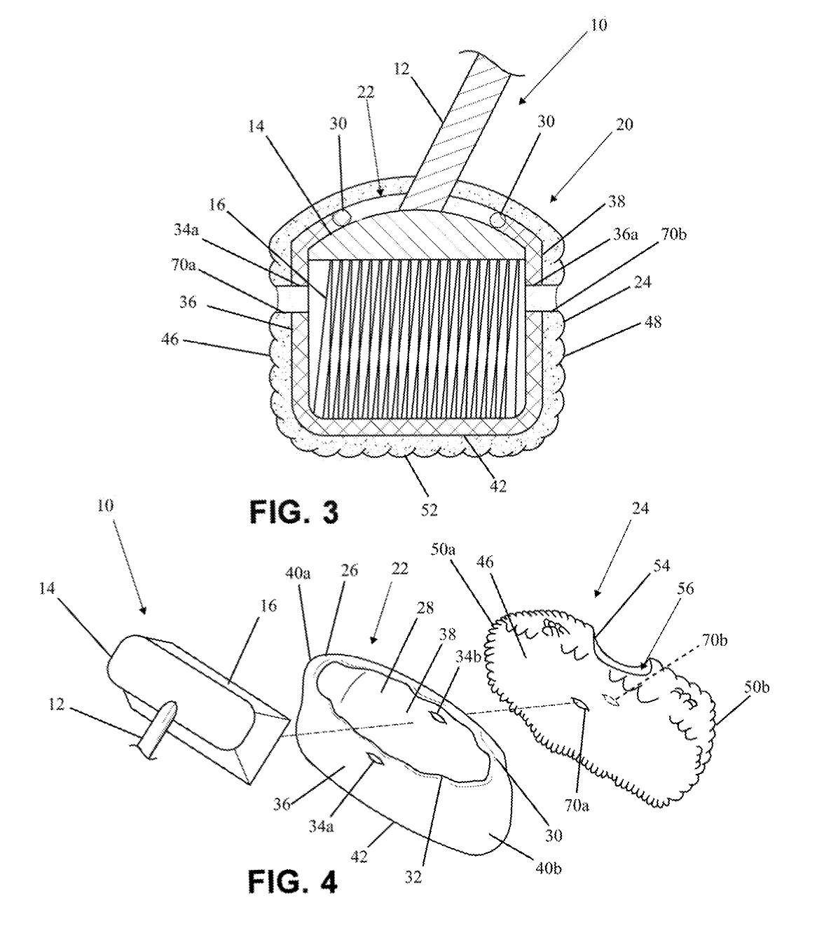

As best illustrated by FIG. 3 and FIG. 4, the brush mitt 20 generally comprises an inner brush liner 22 and an outer brush cover 24. In more detail, the inner brush liner 22 comprises a flexible pocket 26 having an opening 28. The brush liner 22 is flexible in nature and for purposes of example is made of a microfiber towel type material. The inner brush liner 22 flexible pocket 26 is configured to generally shape and completely envelop the brush head 14 and bristles 16. In the version, the flexible pocket 26 has a width approximate the width of the brush 10 head 14 and bristles 16 as well as a length approximate the length of the brush 10 head 14 and bristles. The pocket 26 comprising a front wall 36, a rear wall 38, end side walls 40a, 40b and a bottom wall 42.

Moreover, the inner brush liner 22 further comprises an elastic band 30 positioned about and embedded within the fabric of the perimeter 32 of the opening 28. The elastic band 30 is configured to be removably attachable to the brush head 14 and the bristles 16, wherein the opening 28 of the inner brush liner 22 is configured to expand over and embrace around the brush head 14 and bristles 16, thereby securing the brush mitt 20 to the brush 10 as best illustrated by FIG. 8.

As best illustrated in FIG. 3 and FIG. 4, the inner brush liner 22 further comprises at least one soap vent 34. In the version, there is a first vent 34a and an opposing second vent 34b. The first vent 34a is embedded within the front wall 36 and the second vent 34b is embedded within the opposing rear wall 38. In the version, the vents 34a, 34b are positioned such that when the inner brush liner 22 is attached to the brush head 14 and bristles 16 they are forward and rearward and approximately mid length of the brush bristles 16 as illustrated in FIG. 3. This facilitates and ensures proper egress of soap from the inside of the inner brush liner 22. Alternatively, in other versions, other vent 34 positioning configuration can be envisioned, such as embedded within the end side walls 40a, 40b or located at the bottom wall 42 of the inner brush liner 22.

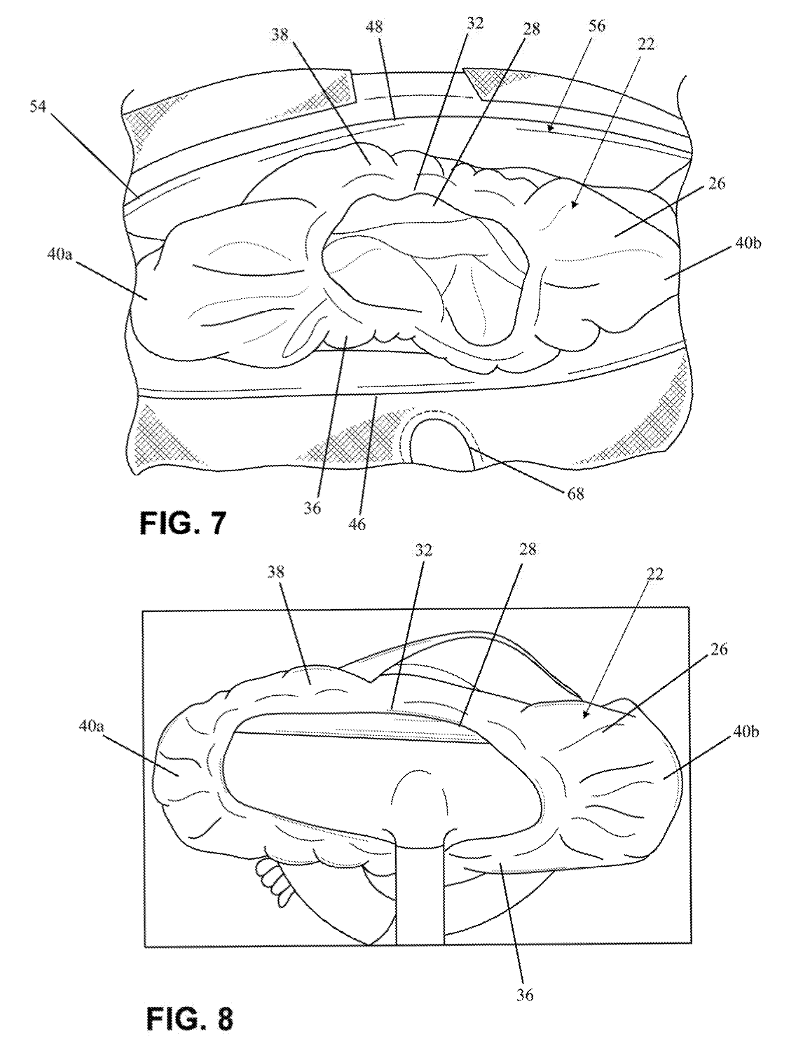

As best depicted by FIG. 1-FIG. 11, the inner brush liner 22 fits within and attaches to the outer brush cover 24. The outer brush cover 24 generally comprises an exterior cleaning surface material 44 which forms a pocket 56. In the illustrated version, the exterior cleaning surface 44 is a chinnelle type cloth (See FIG. 1 and FIG. 2) which is ideal for breaking up dirt, grime, and sand during the washing process. Other soft, non-abrasive, porous materials which will not damage vehicle surfaces may be utilized as the exterior cleaning surface 44—such as all types of microfiber, sheep skin, synthetics, or any type of fibrous material.

The outer brush cover 24 pocket 56 is shaped and sized to snuggly fit over the inner brush liner 22 while fitted to the brush head 14 and bristles 16. In the version, the pocket 56 is generally rectangular in shape resembling a rectangular box having a front wall 46, an opposing rear wall 48, opposing end walls 50a, 50b, bottom wall 52, and an opening 54 at the top. The opening 54 at the top is configured to receive and seat both the inner brush liner 22 and brush head 14 and bristles 16 inside the outer brush cover 24.

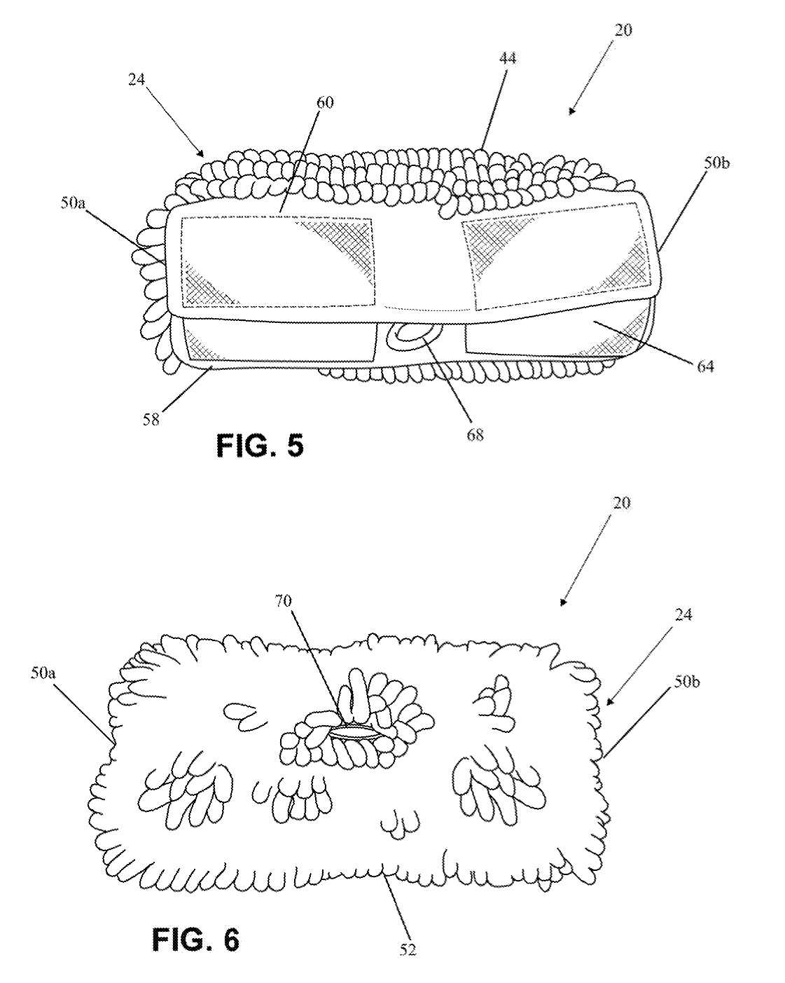

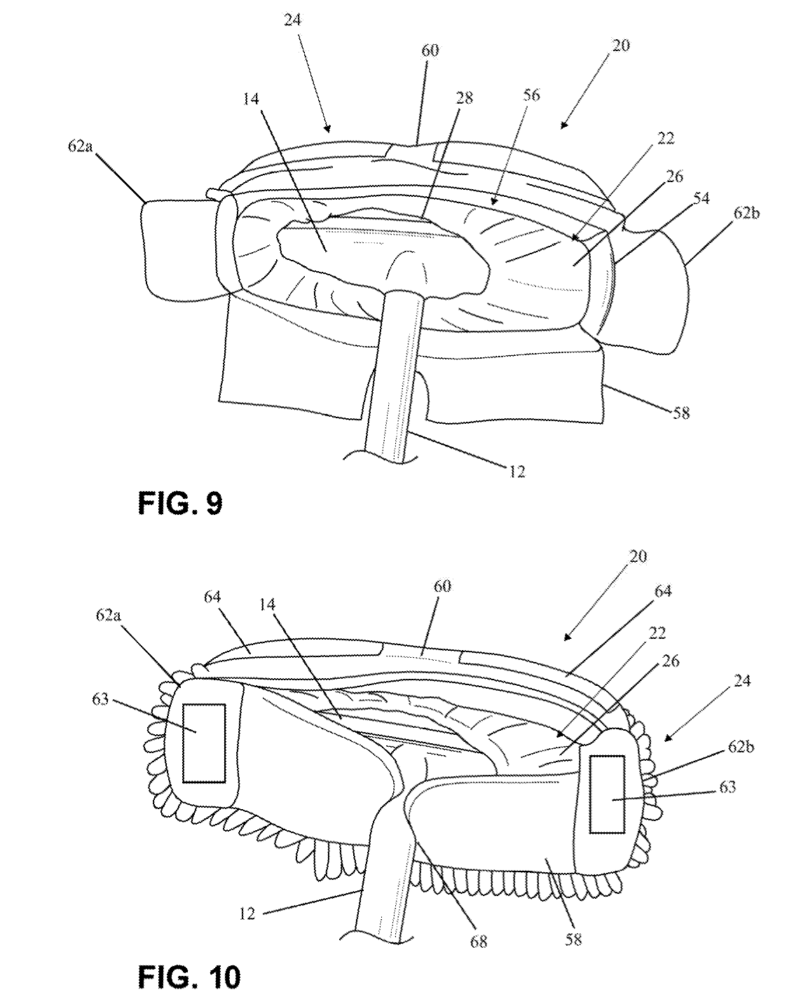

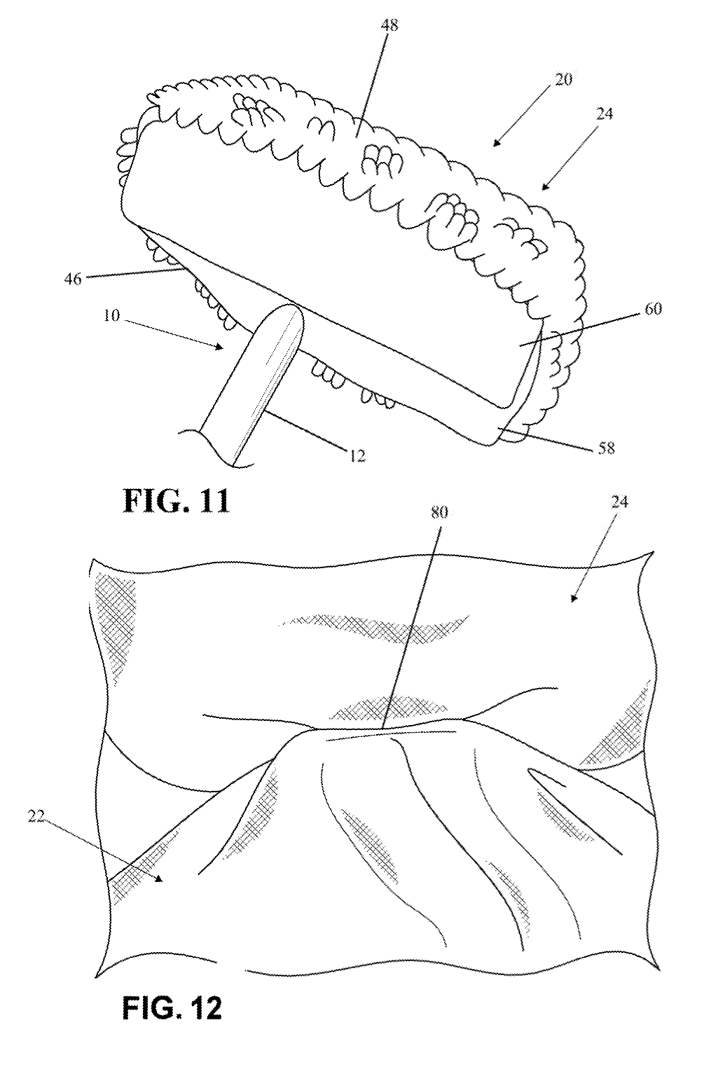

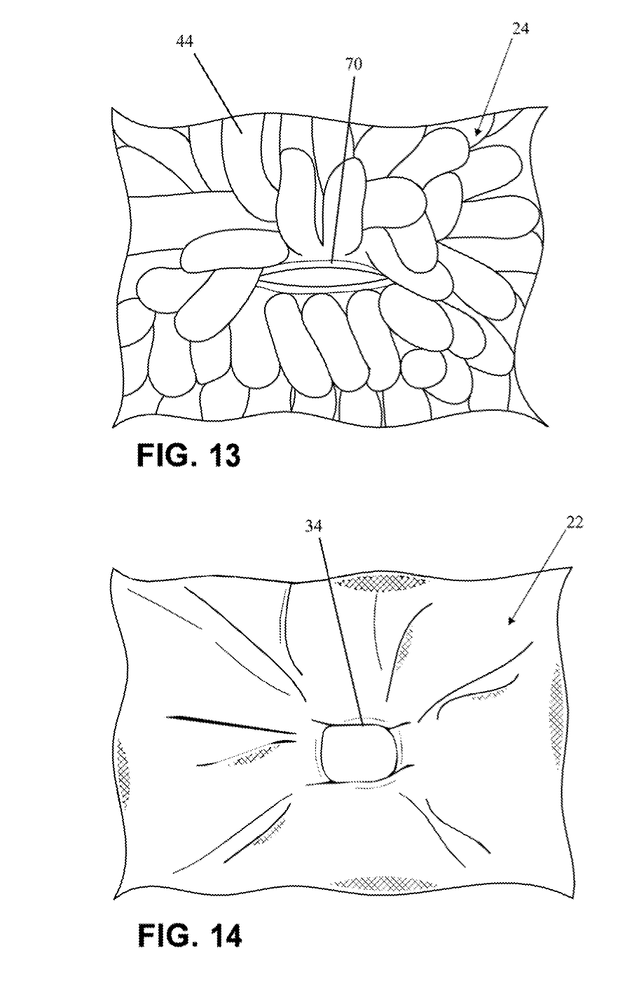

Now referring to FIG. 9-FIG. 13, the outer brush cover 24 further comprises a plurality of closure panels including a first and second longitudinal closure panels 58, 60 as well as opposing end flaps 62a, 62b. The closure panels are configured to close the opening 54 over the brush head 14 and around the handle 12, much like the flaps of a top of a box as is known. The plurality of closure panels utilize Velcro or other attachment means in order to secure the flaps to each other as they they fold over one another. In particular, as illustrated in FIG. 9-FIG. 11, the outer brush cover 24 is closed about the brush head 14 by positioning opposing end flaps 62a, 62b downward over the brush head towards the handle 12. The back surfaces of the opposing end flaps 62a, 62b have Velcro material 63 exposed. Next, the longitudinal closure panel 58 having a slot 68 is folded downward towards the brush head 14 and handle 12 placing the handle 12 within the slot 68. The longitudinal closure panel 58 is affixed to the opposing end flaps 62a, 62b by the Velcro material 63 (FIG. 10). Moreover, the longitudinal closure panel 58 further comprises Velcro material 64 on the exposed surface. Lastly, the final longitudinal closure panel is folded downward towards the brush handle 12 and affixing to the Velcro material 64 of the longitudinal closure panel 58 (FIG. 11). FIG. 5 and FIG. 11 best illustrate the outer brush cover 24 secured to the brush head 14.

Now referring to FIG. 3-FIG. 6, and FIG. 12-FIG. 14, the outer brush cover 24 further comprises at least one soap vent 70 which connects with the at least one soap vent 34 of the inner brush liner 22. The soap vent 70 facilitates egress of soap from the brush head 14 to the exterior cleaning surface 44. In particular, the outer brush cover 24 soap vent 70 and the inner brush liner 22 soap vent 34 are stitched 80 or connected together at their respective perimeters (See FIG. 12), thereby forming a continuous passage from the brush head 14, bristles 16 through the inner brush liner 22 and through the outer brush cover 24—allowing soap to flow from the inside liner directly exterior to the outer brush cover.

The current illustrated version utilizes an opposing dual vent configuration with the outer brush cover 24 having a first vent 70a and an opposing second vent 70b. The first vent 70a is embedded within the front wall 46 and the second vent 70b is embedded within the opposing rear wall 48. Each vent 70a and 70b are respectively connected to the inner brush liner soap vents 34a and 34b allowing passage of soap on each side of the brush 10 and brush mitt 20, effectively delivering soap evenly about the brush head 14 throughout the washing process. Alternatively, in other versions, it can be envisioned that other vent positioning configurations can be utilized in order to deliver soap from within the inner brush liner 22 to the exterior cleaning surface 44.

Ideally, the vents are a horizontal slits within each respective wall material and ideally approximately two (2) inch in width and positioned approximately 1 inch below the top of the front and rear walls 46, 48 of the outer brush cover 24.

The present invention can be made in any manner and of any material chosen with sound engineering judgment. Preferably, materials will be strong, lightweight, long lasting, economic, and ergonomic.

The previously described versions of the present invention have many advantages, including providing a superior cleaning surface which easily adapts to self-service car wash type brushes, avoiding the dirt, grit, and grime which can abrasively destroy the surface of a vehicle. Moreover, brushes 10 are simply insufficient in removing scum and other build up on vehicle surfaces. Furthermore, the design configuration provides an even application of soap to the exterior cleaning surface 44 and the vehicle throughout the washing process.

The invention does not require that all the advantageous features and all the advantages need to be incorporated into every version of the invention.

Although preferred versions of the invention have been described in considerable detail, other versions of the invention are possible.

All the features disclosed in this specification (including and accompanying claims, abstract, and drawings) may be replaced by alternative features serving the same, equivalent or similar purpose unless expressly stated otherwise. Thus, unless stated otherwise, each feature disclosed is one example only of a generic series of equivalent or similar features.

What is claimed is:

1. A brush mitt removably attachable to a car wash brush, the car wash brush comprising a handle, a brush head, and a plurality of bristles attached to the brush head, the brush mitt comprising:
(a) an inner brush liner for enveloping the brush head, comprising
(i) an opening having a perimeter to receive the brush head, wherein the opening comprises an elastic band positioned about the opening perimeter in order to allow the inner brush liner to expand over and embrace around the brush head, wherein the inner brush liner is configured to be removably attachable to the brush head and wherein the brush liner entirely covers the plurality of bristles; and
(ii) at least one vent for facilitating egress of soap as supplied by the brush head, the vent having a perimeter; and
(b) an outer brush cover for providing an exterior cleaning surface formed in the shape of the car wash brush, the outer brush cover comprising:
(i) an opening configured to receive and envelope the brush head and the inner brush liner; and
(ii) at least one vent for facilitating egress of soap exterior of the outer brush, wherein the outer brush cover vent and the inner brush liner vent are connected together at their respective perimeters, thereby allowing soap to flow from inside the inner brush liner directly exterior to the outer brush cover.

2. The brush mitt of claim 1, wherein the exterior cleaning surface is made of a microfiber material.

3. The brush mitt of claim 1, wherein the exterior cleaning surface is made of a chinnelle type material.

4. The brush mitt of claim 1, wherein the inner brush liner further comprises a front wall and a second opposing wall, a first vent embedded within the front wall and a second vent embedded within the second opposing wall, the first vent having a first perimeter and the second vent having a second perimeter; and wherein the outer brush cover further comprises a first wall and a second opposing wall, a third vent embedded within the first wall and a fourth vent embedded within the second opposing wall, wherein the outer brush cover third vent and the inner brush liner first vent are connected together at respective perimeters and the outer brush cover fourth vent and the inner brush liner second vent are connected together at respective perimeters, thereby allowing soap to flow from inside the inner brush liner directly exterior to the outer brush cover.

5. The brush mitt of claim 4, wherein the vents are a horizontal slit approximately 2 inches wide.

6. The brush mitt of claim 4, wherein the vents are connected together by stitching.

7. A brush mitt removably attachable to a car wash brush, the car wash brush comprising a brush handle, a head, and a plurality of bristles attached to the brush head, the brush mitt comprising:
(a) an inner brush liner for enveloping the brush head having a front wall and an opposing rear wall, comprising:
(i) an opening having a perimeter to receive the brush head, wherein the opening comprises an elastic band positioned about the perimeter in order to allow the inner brush liner to expand over and embrace around the brush head, wherein the inner brush liner is configured to be removably attachable to the brush head and wherein the inner brush liner entirely covers the plurality of bristles; and
(ii) a first vent embedded within the front wall and a second vent embedded within the opposing rear wall for facilitating egress of soap as supplied by the brush head, the first vent having a first perimeter and the second vent having a second perimeter; and
(b) an outer brush cover for providing an exterior cleaning surface formed in the shape of the car wash brush having a front wall and an opposing rear wall, the outer brush cover comprising:
(i) an opening configured to receive and envelope the brush head and the inner brush liner; and
(ii) a third vent embedded within the front wall and a fourth vent embedded within the opposing rear wall for facilitating egress of soap exterior of the outer brush, wherein the outer brush cover third vent and the inner brush liner first vent are connected together at respective perimeters and the outer brush cover fourth vent and the inner brush liner second vent are connected together at respective perimeters, thereby allowing soap to flow from inside the inner brush liner directly exterior to the outer brush cover.

8. The brush mitt of claim 7, wherein the exterior cleaning surface is made of a microfiber material.

9. The brush mitt of claim 7, wherein the exterior cleaning surface is made of a chinnelle type material.

10. The brush mitt of claim 7, wherein the vents are a horizontal slit approximately 2 inches wide.

11. The brush mitt of claim 7, wherein the vents are connected together by stitching.

12. A brush mitt removably attachable to a car wash brush, the car wash brush comprising a handle, a brush head, and a plurality of bristles attached to the brush head, the brush mitt comprising:
(a) a flexible inner brush liner for enveloping the brush head having a front wall and an opposing rear wall, comprising:
(i) an opening having a perimeter to receive the brush head, wherein the opening comprises an elastic band positioned about the perimeter in order to allow the inner brush liner to expand over and embrace around the brush head, wherein the inner brush liner is configured to be removably attachable to the brush head and wherein the inner brush liner entirely covers the plurality of bristles; and
(ii) a first vent embedded within the front wall and a second vent embedded within the opposing rear wall for facilitating egress of soap as supplied by the brush head, the first vent having a first perimeter and the second vent having a second perimeter; and
(b) an outer brush cover for providing an exterior cleaning surface having a bottom wall, a front wall, a rear wall, and opposing end walls forming the shape of a rectangular box with an open top, the outer brush cover comprising:
(i) an opening configured to receive and envelope the brush head and the inner brush liner;
(ii) a first and second closure panels hingedly attached to the opening configured to overlap and connect to each other, embracing over the top of the brush while in a closed position, thereby securing and enclosing the outer brush cover to the brush and the inner brush liner; and
(iii) a third vent embedded within the front wall and a fourth vent embedded within the opposing rear wall for facilitating egress of soap exterior of the outer brush, wherein the outer brush cover third vent and the inner brush liner first vent are stitched together at their respective perimeters and the outer brush cover fourth vent and the inner brush liner second vent are stitched together at their respective perimeters, thereby allowing soap to flow from inside the inner brush liner directly exterior to the outer brush cover from the opposing front and rear walls.

13. The brush mitt of claim 12, wherein the exterior cleaning surface is made of a microfiber material.

14. The brush mitt of claim 12, wherein the exterior cleaning surface is made of a chinnelle type material.

15. The brush mitt of claim 12, wherein the vents are a horizontal slit approximately 2 inches wide.
